(19) United States
(12) Patent Application Publication
(10) Pub. No.: US 2012/0026199 A1
(43) Pub. Date: Feb. 2, 2012

(54) IMAGE DISPLAY DEVICE AND IMAGE DISPLAY METHOD

(75) Inventor: Toshio TANAKA, Kobe-shi (JP)

(73) Assignee: FUJITSU TEN LIMITED, Kobe-shi (JP)

(21) Appl. No.: 13/151,842

(22) Filed: Jun. 2, 2011

(30) Foreign Application Priority Data
Jul. 27, 2010 (JP) 2010-168499

(51) Int. Cl. G09G 5/00

(52) U.S. Cl. 345/660

(57) ABSTRACT

A image display device is configured to perform the following operations when generating an enlarged image of an input image from the input image. The image display device first generates an enlarged image by performing an enlarging process on an input image, and generates a reduced image by performing a reducing process other than an inverse process of the enlarging process on the enlarged image. Thereafter, the image display device detects a difference between a pixel value of a pixel on the reduced image and a pixel value of a corresponding pixel on the input image, and corrects a pixel value of a pixel on the input image or the enlarged image based on the detected difference, thereby correcting the enlarged image to be finally output.

### CROSS-REFERENCE TO RELATED APPLICATIONS

This application is based upon and claims the benefit of priority of the prior Japanese Patent Application No. 2010-168499, filed on Jul. 27, 2010, the entire contents of which are incorporated herein by reference.

### BACKGROUND OF THE INVENTION

1. Field of the Invention

The present invention relates to an image display device and an image display method.

2. Description of the Related Art

It is conventionally known that when an image display device displays an input image with a resolution lower than that of a display unit by simply enlarging the input image, because pixels of the input image are enlarged and displayed, diagonal lines and edges in the enlarged image are displayed in a stepwise manner and thus the image quality is degraded.

A bilinear method is a well-known method as one of image interpolation techniques for suppressing such a stepwise display of diagonal lines and edges (see, for example, Japanese Patent Application Laid-open No. 2003-283815).

According to the bilinear method, pixels on an enlarged image are inversely mapped at corresponding positions on an input image, and pixel values of the inversely-mapped pixels on the enlarged image are determined by linear interpolation by using pixel values of nearest four pixels on the input image from the inversely-mapped pixels.

That is, according to the bilinear method, an enlarged image is generated by estimating pixel values of pixels to be interpolated in the enlarged image based on respective values of pixels of the input image.

Therefore, an image display device using the bilinear method can suppress a stepwise display of diagonal lines and edges by blurring the diagonal lines and edges in an enlarged image when an input image with a resolution lower than that of a display unit is to be enlarged and displayed.

However, when an input image with a resolution lower than that of the display unit is to be enlarged and displayed, there is a problem that the image display device using the bilinear method cannot display a high-resolution enlarged image while utilizing the resolution of the display unit.

That is, when an input image with a resolution lower than that of the display unit is to be enlarged and displayed, the image display device using the bilinear method blurs all diagonal lines and edges in the enlarged image.

Consequently, when the image display device using the bilinear method enlarges and displays an input image having regions in which diagonal lines and edges are to be emphasized, the diagonal lines and edges to be emphasized in an enlarged image are blurred, and thus the image quality of the enlarged image is degraded.

Accordingly, when the image display device using the bilinear method enlarges and displays of an input image with a resolution lower than that of the display unit, the image display device cannot display a high-resolution enlarged image while utilizing the resolution of the display unit.

### SUMMARY OF THE INVENTION

It is an object of the present invention to at least partially solve the problems in the conventional technology.

According to an aspect of an embodiment of the invention, An image display device includes an enlarged-image generating unit that generates an enlarged image by performing an enlarging process on an input image; a reduced-image generating unit that generates a reduced image by performing a reducing process other than an inverse process of the enlarging process on the enlarged image; a difference detecting unit that detects a difference between a pixel value of a pixel on the reduced image and a pixel value of a corresponding pixel on the input image; and a correcting unit that corrects a pixel value of a pixel on the input image or the enlarged image based on the difference that is detected by the difference detecting unit.

According to an aspect of an embodiment of the invention, An image display method includes generating an enlarged image by performing an enlarging process on an input image; generating an reduced image by performing a reducing process other than an inverse process of the enlarging process on the enlarged image; detecting a difference between a pixel value of a pixel on the reduced image and a pixel value of a corresponding pixel on the input image; and correcting a pixel value of a pixel on the input image or the enlarged image based on the difference that is detected.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 depicts an outline of an image display technique according to an embodiment of the present invention;

FIG. 2 is a block diagram of a configuration of an image display device according to the embodiment;

FIG. 3 is a block diagram of a configuration of an image enlarging unit according to the embodiment;

FIGS. 4A to 4F depict an operation of an enlarged-image generating unit according to the embodiment;

FIG. 5 depicts an operation of a reduced-image generating unit according to the embodiment;

FIGS. 6A and 6B are examples of an operation of the image enlarging unit according to the embodiment;

FIGS. 7A and 7B are examples of an operation of the image enlarging unit according to the embodiment;

FIG. 8 is an example of an operation of the image enlarging unit when repeating a feedback of a difference to a latter-stage adding unit according to the embodiment for plural times;

FIGS. 9A and 93 are examples of an operation of the image enlarging unit when repeating a feedback of a difference to the latter-stage adding unit according to the embodiment for plural times; and

FIG. 10 is a flowchart of a process performed by the image display device according to the embodiment.

### DETAILED DESCRIPTION OF THE PREFERRED EMBODIMENTS

Exemplary embodiments of an image display device and an image display method according to the present invention will be explained below in detail with reference to the accompanying drawings.

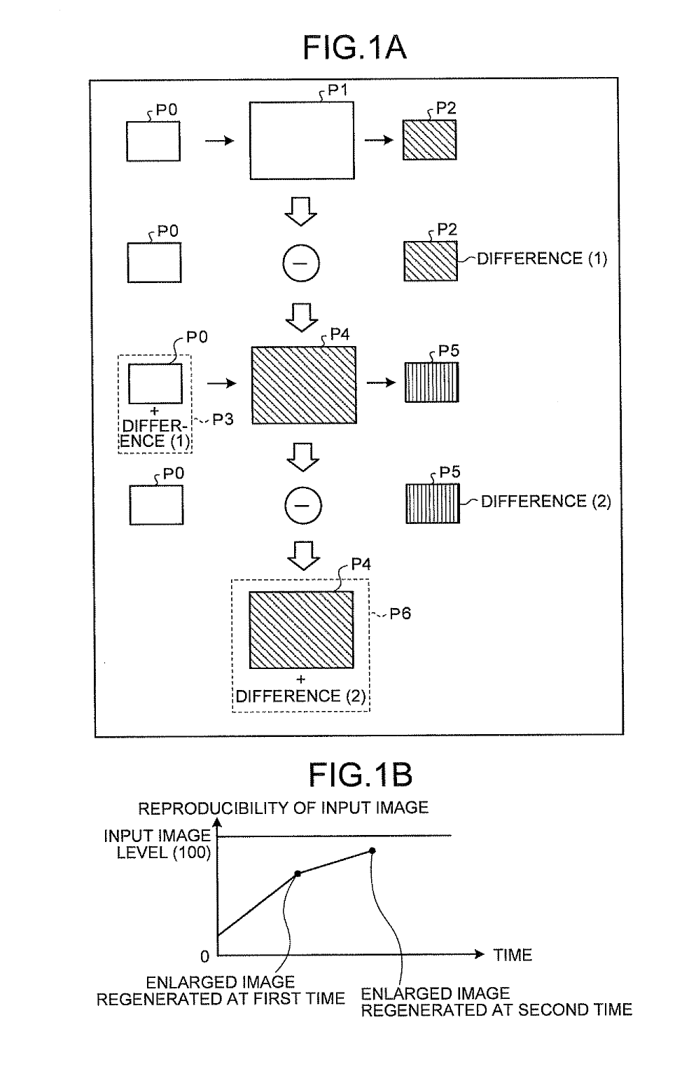

Prior to detailed explanations of an embodiment of the present invention, an outline of an image display technique according to the embodiment is explained with reference to FIG. 1. FIG. 1 depicts the outline of the image display technique.

The image display technique according to the present embodiment is a technique of displaying a high-precision enlarged image of an input image in a display unit when the input image with a resolution lower than that of the display unit is to be enlarged and displayed while utilizing the resolution of the display unit that displays the image.

Specifically, as shown in FIG. 1A, in the image display technique according to the present embodiment, an enlarged image P1 is generated by performing a predetermined enlarging process on an input image P0. Next, in the image display technique, a reducing process other than an inverse process of the enlarging process performed when generating the enlarged image P1 is performed on the enlarged image P1, thereby generating a reduced image P2.

At this time, in the image display technique according to the present embodiment, the reduced image P2 having the same image size as that of the input image P0 is generated. Next, as shown in FIG. 1A, in the image display technique, a difference (1) between a pixel value of a pixel on the input image P0 and a pixel value of a corresponding pixel on the input image P2 is detected.

At this detection, when the reproducibility of the input image P0 due to the enlarged image P1 is not decreased by the enlarging process, the value of the difference (1) becomes substantially “0”, and the value of the difference (1) becomes larger or smaller than “0” when the decreasing level of the reproducibility is larger.

Therefore, in the image display technique according to the present embodiment, as shown in FIG. 1A, an input image P3 is generated by correcting a pixel value of a pixel on the input image P0 by adding the difference (1) to a pixel value of a corresponding pixel on the input image P0. An enlarged image P4 is then generated by performing an enlarging process on the input image P3 having its pixel value corrected.

In this manner, in the image display technique according to the present embodiment, a pixel value of a pixel on the input image P0 is corrected based on an assumption that the reproducibility of the input image is decreased by the enlarging process. In the image display technique according to the present embodiment, the enlarged image P4 is regenerated from the input image P3 having its pixel value corrected. Therefore, according to the image display technique, the enlarged image P4 with a reproducibility of the input image higher than that of the enlarged image P1 can be regenerated.

In the image display technique according to the present embodiment, a reducing process other than an inverse process of the enlarging process performed when generating the enlarged image P4 is performed on the regenerated enlarged image P4, thereby regenerating a reduced image P5.

Next, as shown in FIG. 1A, in the image display technique according to the present embodiment, a difference (2) between a pixel value of a pixel on the initially input image P0 of which a pixel value is not corrected and a pixel value of a corresponding pixel on the regenerated reduced image P5 is redetected.

At this redetection, when the reproducibility of the input image due to the enlarged image P4 is sufficiently improved, the value of the difference (2) becomes substantially “0”, and when the reproducibility of the input image due to the enlarged image 94 is not sufficiently improved, the value of the difference (2) becomes larger or smaller than “0”.

Therefore, in the image display technique according to the present embodiment, as shown in FIG. 1A, an enlarged image P6 of a corrected pixel value is regenerated by adding the difference (2) to a pixel value of a corresponding pixel on the regenerated enlarged image P4.

As explained above, in the image display technique according to the present embodiment, the enlarged image P6 with a reproducibility of the input image P0 higher than that of the input image P0 due to the enlarged image P4 can be generated by reflecting on the enlarged image P6 a difference between a pixel value of a pixel on the reduced image P5 of the enlarged image P4 and a pixel value of a pixel on the input image P0.

With this arrangement, according to the image display technique of the present embodiment, as shown in FIG. 1B, the reproducibility of the input image P0 due to the enlarged image can be improved each time when an enlarged image is regenerated.

Further, in the image display technique according to the present embodiment, it is possible to repeatedly perform an addition of a difference to a pixel value of a pixel on an enlarged image, a regeneration of a reduced image from an enlarged image to which a difference is added, and a redetection of a difference between a pixel value of a pixel on the regenerated reduced image and a pixel value of a pixel on the input image P0.

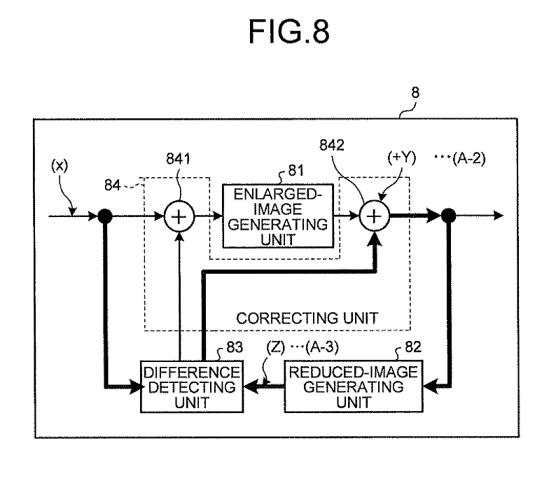

With this arrangement, in the image display technique according to the present embodiment, the reproducibility of an input image due to an enlarged image can be improved only by repeating an addition of a difference to a pixel value of a pixel on an enlarged image without repeatedly performing an enlarging process. Details of this repeating process are described later with reference to FIG. 8.

As described above, in the image display technique according to the present embodiment, a pixel value of a pixel on an input image is corrected based on an assumption that the reproducibility of the input image is decreased by an enlarging process. In the image display technique according to the present embodiment, an enlarged image is regenerated from an input image of which a pixel value is corrected. Therefore, according to the image display technique, it is possible to regenerate an enlarged image with a reproducibility of an input image higher than that of an enlarged image generated from an initially input image of which a pixel value is not corrected.

Further, in the image display technique according to the present embodiment, an enlarged image is regenerated, which reflects a difference between a pixel value of a pixel on a reduced image of a regenerated enlarged image and a pixel value of a pixel on an initially input image. Therefore, according to the image display technique, it is possible to regenerate an enlarged image with a reproducibility of an input image higher than that of an enlarged image generated from an input image of which a pixel value is corrected.

As explained above, in the image display technique according to the present embodiment, because an enlarged image with an improved reproducibility of an input image can be generated, when an input image with a resolution lower than that of the display unit is enlarged and displayed, a high-precision enlarged image utilizing the resolution of the display unit can be displayed.

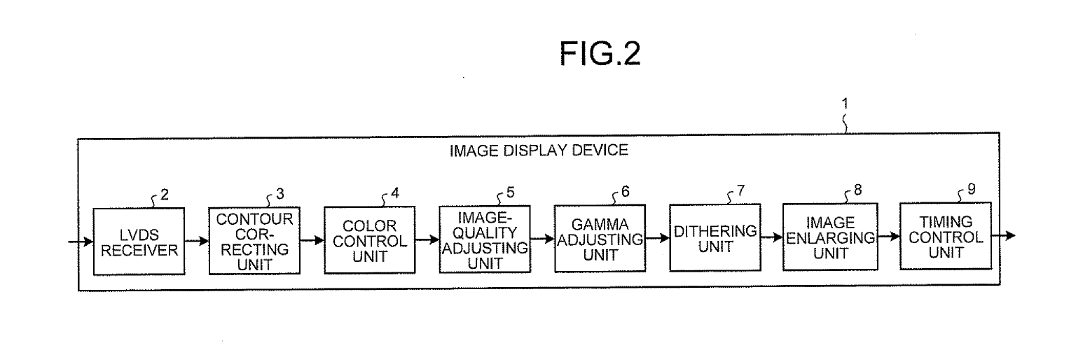

An embodiment of an image display device and an image display method to which the image display technique according to the present embodiment is applied are explained below in detail with reference to FIGS. 2 to 10.

As an example, an in-vehicle image display device that displays a one-segment broadcasting image and an image input from a car navigation system as well as an image of normal digital television broadcasting that uses 12 segments is explained below.

FIG. 2 is a block diagram of a configuration of an image display device 1 according to the present embodiment. FIG. 2 depicts only constituent elements necessary to explain the characteristics of the image display device 1, and descriptions of general constituent elements will be omitted.

As shown in FIG. 2, the image display device 1 includes a low-voltage differential signaling (LVDS) receiver 2, a contour correcting unit 3, a color control unit 4, an image-quality adjusting unit 5, a gamma adjusting unit 6, a dithering unit 7, an image enlarging unit 8, and a timing control unit 9.

The LVDS receiver 2 is an image interface that receives an input of an image signal from a digital-broadcast receiving unit (not shown) or the like, and outputs a received image signal to the contour correcting unit 3. An image corresponding to an image signal received by the LVDS receiver 2 is hereinafter referred to as “input image”.

The image signal in the present embodiment includes respective pixel values of each pixel on an input image. The pixel value represents the strength of R (red), G (green), B (blue) in each pixel and the brightness of each pixel.

The contour correcting unit 3 is a processing unit that performs a contour correcting process of emphasizing a contour of a subject, a character, a graph or the like in an input image on an image signal that is input from the LVDS receiver 2, and outputs the image signal after the contour correcting process to the color control unit 4.

The color control unit 4 is a processing unit that performs a color control process of adjusting a shade of a subject, a graph or the like in an input image and gradation of a color to an image signal that is input from the contour correcting unit 3, and outputs an image signal after the color control process to the image-quality adjusting unit 5.

The image-quality adjusting unit 5 is a processing unit that performs an image-quality adjusting process of adjusting the contrast and brightness of an input image on an image signal that is input from the color control unit 4, and outputs an image signal after the image-quality adjusting process to the gamma adjusting unit 6.

The gamma adjusting unit 6 is a processing unit that performs a gamma adjusting process of correcting a gamma value of each pixel according to the display characteristics of a display unit (not shown) that displays an image on an image signal that is input from the image-quality adjusting unit 5, and outputs an image signal after the gamma adjusting process to the dithering unit 7.

The dithering unit 7 is a processing unit that performs a dithering process of causing a display unit to express an intermediate color to be expressed by an expressible chromatic number on an image signal that is input from the gamma adjusting unit 6, and outputs an image signal after the dithering process to the image enlarging unit 8.

The image enlarging unit 8 is a processing unit that performs, when enlargement of a input image is used, an enlarging process of matching an image size of the input image with a size of a display region of a display unit on an image signal that is input from the dithering unit 7, and outputs an image signal after the enlarging process to the timing control unit 9.

The image enlarging unit 8 performs the enlarging process on an image signal of an input image when the resolution of the input image is lower than that of the display unit and also when the input image is displayed in an image size smaller than the display region of the display unit when the image signal is output as it is.

The image enlarging unit 8 outputs an image signal that is input from the dithering unit 7 as it is to the timing control unit 9 when enlargement of an input image is not used, that is, when the resolution of the input image is equal to or higher than that of the display unit.

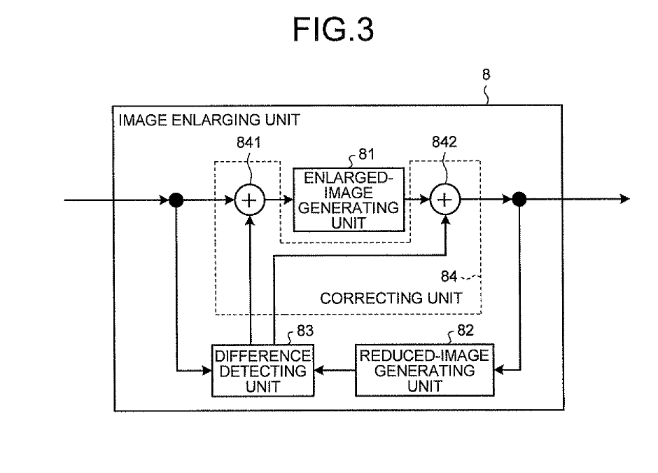

Particularly, the image enlarging unit 8 is configured to generate a high-precision enlarged image utilizing the resolution of the display unit by correcting a pixel value of a pixel on an input image or the resolution of an enlarged image generated from the input image, when the input image in enlarged and displayed. Details of the configuration and operations of the image enlarging unit 8 are described later with reference to FIGS. 3 to 10.

The timing control unit 9 is a processing unit that causes a display unit to display an image by outputting an image signal input from the image enlarging unit 8 to the display unit at a predetermined timing. For example, the timing control unit 9 outputs an image signal at a timing synchronized with a horizontal synchronization signal and a vertical synchronization signal having been determined in advance by the display unit.

The configuration of the image enlarging unit 8 according to the present embodiment is explained next. FIG. 3 is a block diagram of the configuration of the image enlarging unit 8. As shown in FIG. 3, the image enlarging unit 8 includes an enlarged-image generating unit 81, a reduced-image generating unit 82, a difference detecting unit 83, and a correcting unit 84. The correcting unit 84 includes a former-stage adding unit 841 and a latter-stage adding unit 842.

The enlarged-image generating unit 81 is a processing unit that generates an enlarged image of an input image from the dithering unit 7 by performing an enlarging process using the bilinear method on an image signal of the input image via the former-stage adding unit 841.

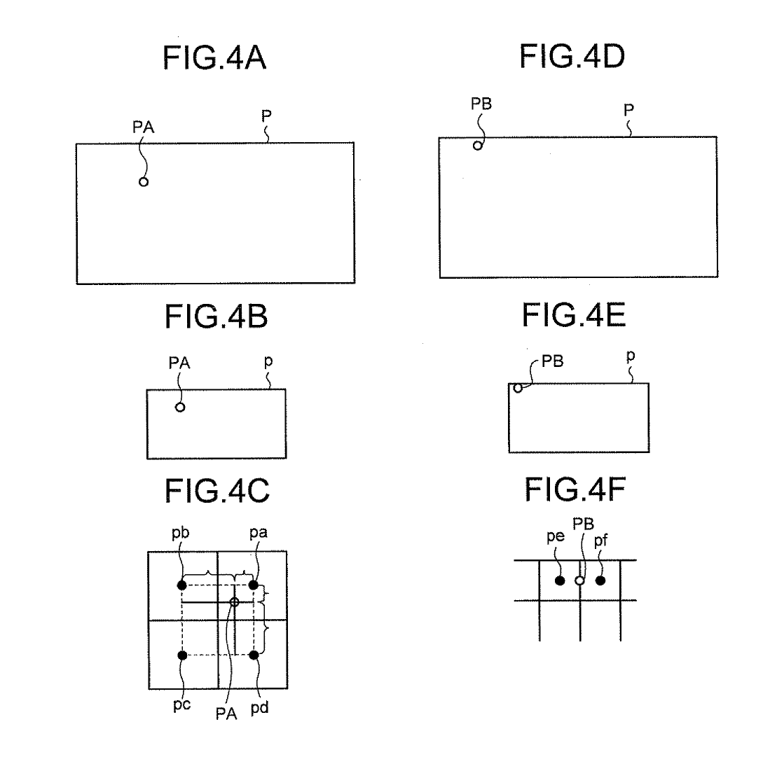

The enlarged-image generating unit 81 then outputs an image signal of a generated enlarged image to the timing control unit 9 or the reduced-image generating unit 82 via the latter-stage adding unit 842. An operation of the enlarged-image generating unit 81 is explained below with reference to FIGS. 4A to 4F.

FIGS. 4A to 4F depict an operation of the enlarged-image generating unit 81 according to the present embodiment. The operation is explained based on an assumption that the resolution of an input image is 400×234 pixels (EGA) and the resolution of a display unit is 800×480 pixels (VGA).

The enlarged-image generating unit 81 inversely maps each of 800×480 pixels that constitute an enlarged image to be generated onto an input image. The enlarged-image generating unit 81 then determines a pixel value of each pixel on an enlarged image by linear interpolation using pixel values of four pixels that are nearest to pixels of the enlarged image that is inversely mapped on the input image.

For example, when determining a pixel value of a pixel PA on an enlarged image P shown in FIG. 4A, the enlarged-image generating unit 81 first inversely maps the pixel PA on the enlarged image P at a coordinate position on an input image p corresponding to a coordinate position of the pixel PA on the enlarged image P, as shown in FIG. 4B.

Next, as shown in FIG. 4C, the enlarged-image generating unit 81 detects coordinate positions in the input image p of four pixels pa, pb, pc, and pd that are nearest to the pixel PA that is inversely mapped on the input image p.

The enlarged-image generating unit 81 then calculates a ratio of two distances, which are a distance from a straight line that connects two pixels pa and pd on the input pixel p to the inversely mapped pixel PA, and a distance from a straight line that connects two pixels pb and pc on the input pixel p to the inversely mapped pixel PA.

The enlarged-image generating unit 81 calculates a ratio of two distances, which are a distance from a straight line that connects two pixels pa and pb on the input pixel p to the inversely mapped pixel PA, and a distance from a straight line that connects two pixels pc and pd on the input pixel p to the inversely mapped pixel PA.

Next, the enlarged-image generating unit 81 determines a pixel value of the inversely mapped pixel PA by performing linear interpolation by using the calculated ratios and pixel values of the four pixels pa, pb, pc, and pd on the input image p.

When determining a pixel value of a pixel PB that constitutes an edge of the enlarged image P as shown in FIG. 4D, the enlarged-image generating unit 81 inversely maps the pixel PB on the enlarged image P at a coordinate position on the input image p corresponding to a coordinate position of the pixel PB on the enlarged image P as shown in FIG. 4E.

Next, as shown in FIG. 4F, the enlarged-image generating unit 81 determines a pixel value of the inversely mapped pixel PB by performing linear interpolation by using pixel values of two pixels pe and pf that are adjacent to the inversely mapped pixel PB.

For example, as shown in FIG. 4F, when the inversely mapped pixel PB is present at a middle point between the two pixels pe and pf on the input image p, the enlarged-image generating unit 81 determines an intermediate value of the pixel values of the two pixels pe and pf on the input image p as a pixel value of the pixel PB.

The enlarged-image generating unit 81 generates the enlarged image P of the input image by performing the determining process of a pixel value on all pixels of the enlarged image to be generated. The enlarging process performed by the enlarged-image generating unit 81 is not limited to the enlarging process using the bilinear method, and can be an enlarging process using a bicubic method, for example.

Referring back to FIG. 3, the reduced-image generating unit 82 is a processing unit that generates a reduced image by performing a reducing process of reducing an image size of an enlarged image to an image size of the input image p on the image signal of the enlarged image P that is input from the enlarged-image generating unit 81. The reduced-image generating unit 82 outputs an image signal of the generated reduced image to the difference detecting unit 83.

The reduced-image generating unit 82 generates a reduced image by performing a reducing process other than the inverse process of the enlarging process performed by the enlarged-image generating unit 81. For example, the reduced-image generating unit 82 can perform a reducing process using a method of generating a reduced image by dividing an enlarged image into plural pixel blocks and by averaging pixel values of the pixels included in each of the pixel blocks (hereinafter, “average thinning method”).

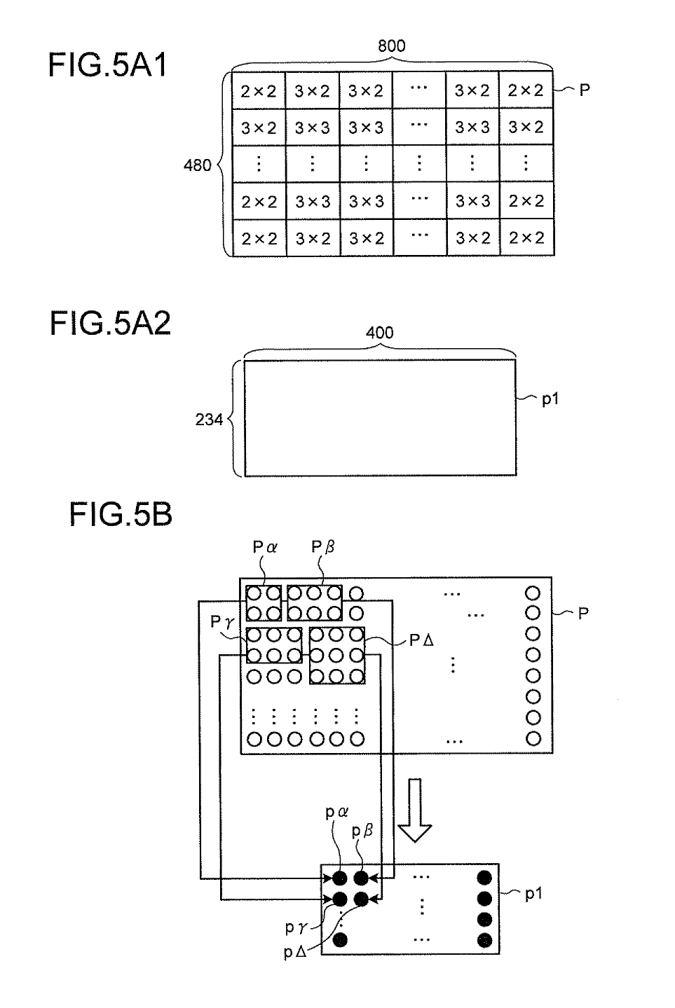

An operation of the reduced-image generating unit 82 is explained with reference to FIG. 5. FIG. 5 depicts an operation of the reduced-image generating unit 82 according to the present embodiment. The reduced-image generating unit 82 generates a reduced image p1 of 400×234 pixels shown in FIG. 5A2 from the enlarged image P of 800×480 pixels shown in FIG. 5A1.

For example, as shown in FIG. 5A1, the reduced-image generating unit 82 divides the enlarged image P into plural pixel blocks including 2×2 pixels, 3×2 pixels, and 3×3 pixels, and calculates an average value of pixel values within each of the pixel blocks. When the enlarged image P is divided into plural pixel blocks, pixel values of pixels as fractions that cannot be included in each of the pixel blocks are not used as data for calculating the average value.

The reduced-image generating unit 82 generates the reduced image p1 by determining that an average value of pixel values within each of the calculated pixel blocks is a pixel value of each pixel on the reduced image p1 corresponding to each of the pixel blocks.

Specifically, as shown in FIG. 5B, the reduced-image generating unit 82 determines that an average value of pixel values included in a pixel block Pα constituted by four pixels at an upper left end of the enlarged image P is a pixel value of a pixel pa at an upper left end of the reduced image p1.

Similarly, the reduced-image generating unit 82 determines that average values of pixel values within pixel blocks Pβ, Pγ, and PΔ, respectively of the enlarged image P are pixel values of corresponding pixels Pβ, Pγ, and PΔ on the reduced image p1.

The reducing process performed by the reduced-image generating unit 82 is not limited to a reducing process using the average thinning method, and other reducing processes using an arbitrary method such as the bicubic method can be also used as far as the method thereof is other than that of the inverse process of the enlarging process performed by the enlarged-image generating unit 81.

Referring back to FIG. 3, the difference detecting unit 83 is a processing unit that detects, based on an image signal of an input image that is input from the dithering unit 7 and an image signal of a reduced image that is input from the reduced-image generating unit 82, a difference between a pixel value of a pixel on an input image and a pixel value of a corresponding pixel on a reduced image, and outputs the difference to the correcting unit 84.

The difference detecting unit 83 detects a difference between a pixel value of a pixel on an input image and a pixel value of a corresponding pixel on a reduced image by subtracting a pixel value of a pixel on the reduced image from a pixel value of each pixel on the input image.

Next, when an image signal of a reduced image is input from the reduced-image generating unit 82 at a first time after an image signal of a new input image is input to the image enlarging unit 8, the difference detecting unit 83 outputs a detected difference to the former-stage adding unit 841 of the correcting unit 84.

Thereafter, when an image signal of a reduced image is input from the reduced-image generating unit 82 at a second time or after the second time after an image signal of a new input image is input to the image enlarging unit 8, the difference detecting unit 83 outputs a detected difference to the latter-stage adding unit 842 of the correcting unit 84.

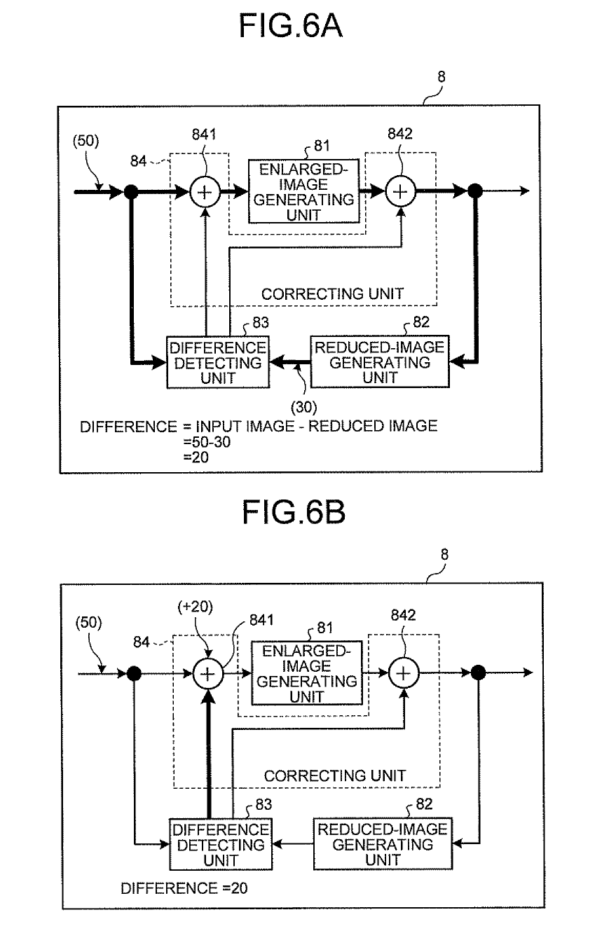

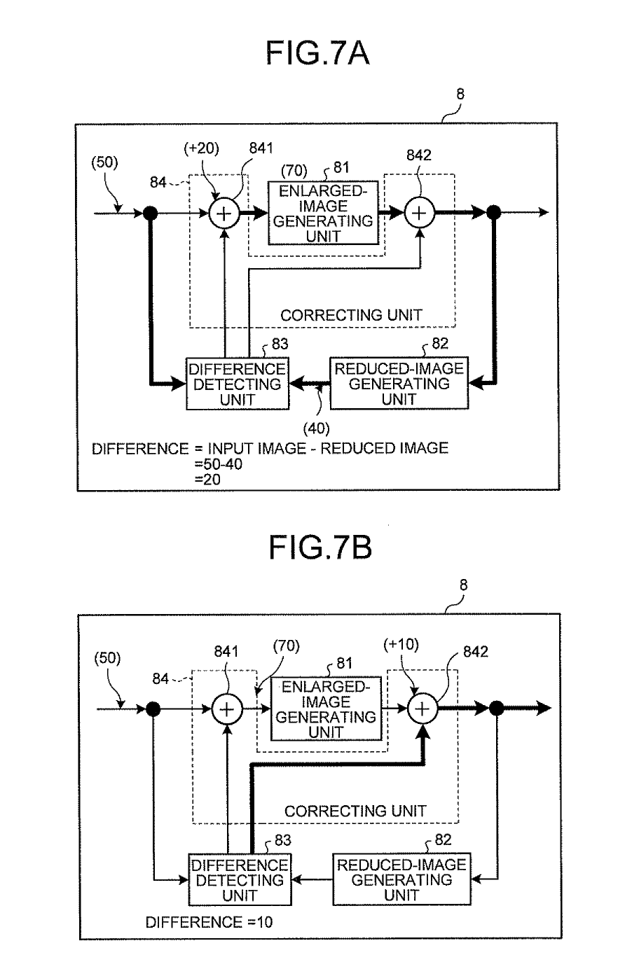

The correcting unit 84 is a processing unit that improves the reproducibility of an input image of an enlarged image by correcting a pixel value of a pixel on an input image or the enlarged image based on a difference that is input from the difference detecting unit 83. An example of an operation of the image enlarging unit 8 is explained based on an operation of the correcting unit 84 with reference to FIGS. 6A and 6B and FIGS. 7A and 7B.

FIG. 6 and FIG. 7 are examples of the operation of the image enlarging unit 8 according to the present embodiment. An example of the operation of the image enlarging unit 8 performed on a certain pixel (hereinafter, “target pixel”) of an input image is explained here. Numerical values within parenthesis in FIGS. 6 and 7 denote pixel values and numerical values within parenthesis with a sign “+” (plus) denote differences to be added to pixel values.

In the following explanations, an image signal of an input image is referred to as “input image”, an image signal of an enlarged image is referred to as “enlarged image”, and an image signal of a reduced image is referred to as “reduced image”, to facilitate explanations.

As shown in FIG. 6A, in the image enlarging unit 8, an input image that is input from the dithering unit 7 is input to the enlarged-image generating unit 81 and to the difference detecting unit 83 via the former-stage adding unit 841.

When an input image is input, the enlarged-image generating unit 81 generates an enlarged image from the input image by an enlarging process using the bilinear method described above, and outputs the generated enlarged image to the reduced-image generating unit 82.

Next, when the enlarged image is input from the enlarged-image generating unit 81, the reduced-image generating unit 82 generates a reduced image having the same image size as that of the input image from the enlarged image by a reducing process using the average thinning method described above, and outputs the generated reduced image to the difference detecting unit 83.

It is assumed that a pixel value of a target pixel on the input image is (50) and that a pixel value of the target pixel on the reduced image is (30), as shown in FIG. 6A. That is, it is assumed that a pixel value of the target image that is (50) at the beginning is decreased to (30) after undergoing the enlarging process and the reducing process.

The difference detecting unit 83 then detects a difference between pixel values of corresponding pixels by subtracting a pixel value of a pixel on the reduced image from a pixel value of a corresponding pixel on the input image. In this case, the difference detecting unit 83 detects (20) as a difference between pixel values of the target pixel.

Performing the enlarging process and the reducing process on the input image can be assumed as the cause of a decrease of the pixel value of the target pixel from (50) to (30). Therefore, the pixel value of the target pixel on the reduced image can be set closer to the initial value of (50) by increasing the pixel value of the target pixel on the input image by 20 and by further performing the enlarging process and the reducing process again.

That is, the reproducibility of an input image due to the enlarged image can be improved by adding a difference detected at the first time to a pixel value of the corresponding pixel and by performing the enlarging process and the reducing process at the second time. Therefore, the difference detecting unit 83 outputs a difference of each pixel detected at a first detection of the difference to the former-stage adding unit 841, as shown in FIG. 6B.

As shown in FIG. 7A, the former-stage adding unit 841 adds a difference that is input from the difference detecting unit 83 to respective pixel values of a corresponding pixel on the input image, and outputs the input image having added with the difference to the enlarged-image generating unit 81.

Next, the enlarged-image generating unit 81 regenerates an enlarged image from the input image having added with a difference for each corresponding pixel, and outputs a regenerated enlarged image to the reduced-image generating unit 82. The reduced-image generating unit 82 then regenerates a reduced image from the regenerated enlarged image, and outputs the regenerated reduced image to the difference detecting unit 83.

The difference detecting unit 83 then redetects a difference between pixel values of each pixel by subtracting a pixel value of a pixel on the regenerated reduced image from a pixel value of a corresponding pixel on the input image. As shown in FIG. 7A, the difference detecting unit 83 detects (10) as a difference between pixel values of a target pixel when a pixel value of the target pixel on the regenerated reduced image is (40).

In this manner, a difference between a pixel value of a pixel on the input image and a pixel value of a corresponding pixel on a reduced image can be decreased by feeding back a result of the first detection of the difference to a pixel value of a corresponding pixel on the input image, where the first detection is performed by the difference detecting unit 83. That is, the reproducibility of the input image due to the enlarged image can be improved by the feedback.

However, when the feedback is repeated for plural times, the enlarging process needs to be performed each time. Therefore, as shown in FIG. 7B, the difference detecting unit 83 outputs a difference between pixel values of each pixel detected at a second detection of the difference to the latter-stage adding unit 842.

Next, the latter-stage adding unit 842 adds a redetected difference (10) to the pixel value of the target pixel. That is, the latter-stage adding unit 842 feeds back and adds the difference that is input from the difference detecting unit 83 to a pixel value of a corresponding pixel on the enlarged image that is input from the enlarged-image generating unit 81.

The latter-stage adding unit 842 then outputs an enlarged image that is generated by adding the difference to the timing control unit 9. In this manner, the reproducibility of the input image due to the enlarged image can be also improved by adding a difference detected by the difference detecting unit 83 to the enlarged image.

When a difference detected by the difference detecting unit 83 is added to the enlarged image in this way, the reproducibility of the input image due to the enlarged image improved by feeding back (rough adjusting) the difference to the former-stage adding unit 841 can be further improved (finely adjusted) while omitting the enlarging process.

While an enlarged image is output to the timing control unit 9 after a difference is fed back once to the latter-stage adding unit 842, the difference can be fed back to the latter-stage adding unit 842 repeatedly.

That is, operations such that the latter-stage adding unit 842 adding a difference to a pixel value of an enlarged image, the reduced-image generating unit 82 generating a reduced image, and the difference detecting unit 83 detecting a difference between pixel values are repeatedly performed, and when a predetermined ending condition is satisfied after repeating these operations, an enlarged image can be output to the timing control unit 9.

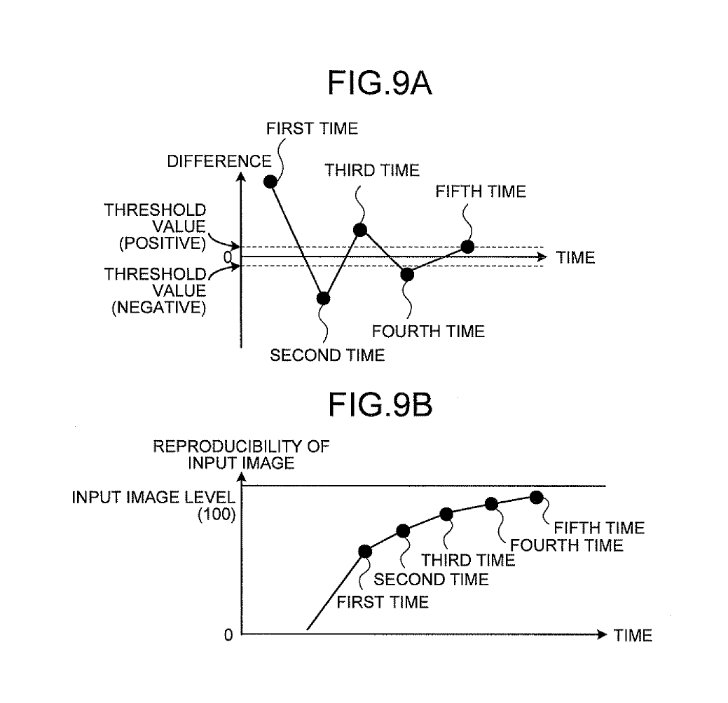

An example of an operation of the image enlarging unit 8 when repeating a feedback of a difference to the latter-stage adding unit 842 for plural times is explained with reference to FIG. 8 and FIGS. 9A and 9B. FIG. 8 and FIGS. 9A and 9B are examples of the operation of the image enlarging unit 8 when repeating a feedback of a difference to the latter-stage adding unit 842 according to the present embodiment for plural times.

As shown in FIG. 8, in the image enlarging unit 8, when a difference between pixel values of a target pixel detected at an N-th time by the difference detecting unit 83 is (Y) ((N-TH)DIFFERENCE=Y), the difference detecting unit 83 outputs the detected difference (Y) to the latter-stage adding unit 842. At this time, the difference detecting unit 83 outputs differences between pixel values of all pixels on the input image to the latter-stage adding unit 842.

Next, the latter-stage adding unit 842 adds the difference (Y) to a corresponding pixel value of the target pixel on the enlarged image that is input from the enlarged-image generating unit 81 (see (A-2) in FIG. 8). The latter-stage adding unit 842 then outputs to the reduced-image generating unit 82 an enlarged image that is generated by adding differences between pixel values of all pixels on the enlarged image.

The reduced-image generating unit 82 then generates a reduced image from the enlarged image that is input from the latter-stage adding unit 842, and outputs the generated reduced image to the difference detecting unit 83. At this time, it is assumed that a pixel value of a target pixel is (Z) (see (A-3) in FIG. 8).

In this case, the difference detecting unit 83 detects (X−Z) as a result of an (N+1)-th detection of a difference between pixel values of the target pixel (((N+1)-TH) DIFFERENCE=Y−Z). In this case, the difference detecting unit 83 detects differences between pixel values of all pixels on the input image and pixel values of all pixels on the reduced image, and outputs each of the detected differences of each pixel to the latter-stage adding unit 842.

Thereafter, in the image enlarging unit 8, operations such that the latter-stage adding unit 842 adding a difference between pixel values of a target pixel to a pixel value on an enlarged image, the reduced-image generating unit 82 generating a reduced image, and the difference detecting unit 83 detecting a difference between pixel values are repeatedly performed.

In the image enlarging unit 8, when an absolute value of a difference detected by the difference detecting unit 83 becomes equal to or smaller than a predetermined threshold value (|DIFFWEWNCE|≦THREDHOLD VALUE) the feedback of a difference to the latter-stage adding unit 842 ends (END FEEDBACK).

At this time, the feedback can be ended when absolute values of differences for all pixels become equal to or smaller than a predetermined threshold value or when an average of absolute values of differences for all pixels becomes equal to or smaller than a predetermined threshold value. Alternatively, the feedback can be ended when the number of pixels of which differences between pixel values become equal to or smaller than a predetermined threshold value exceeds a predetermined number.

The image enlarging unit 8 outputs an enlarged image that is output by the latter-stage adding unit 842 to the timing control unit 9 when the feedback is ended(OUTPUT ENLARGED IMAGE).

As described above, as shown in FIG. 9A, by repeating a feedback of a difference to the latter-stage adding unit 842 for plural times, the image display device 1 can set a difference between a pixel value of a target pixel on the input image and a pixel value of the target pixel on the reduced image close to 0, each time when the feedback is repeated.

By performing processes described above, as shown in FIG. 9B, the image display device 1 can set the reproducibility of the input image due to the enlarged image close to the level of the input image each time when the feedback is repeated.

Therefore, for example, even when an input image having a region in which diagonal lines or edges may be emphasized is enlarged and displayed, the image display device 1 can display a high-definition enlarged image while utilizing the resolution of the display unit because the diagonal lines and edges can be correctly reproduced.

Although an ending condition in this example is that an absolute value of a difference becomes equal to or smaller than a predetermined threshold value, the ending condition can be that the number of times of feedbacks to a difference of the latter-stage adding unit 842 reaches a predetermined number of times set in advance. With this arrangement, a processing amount used for a feedback of a difference can be restricted.

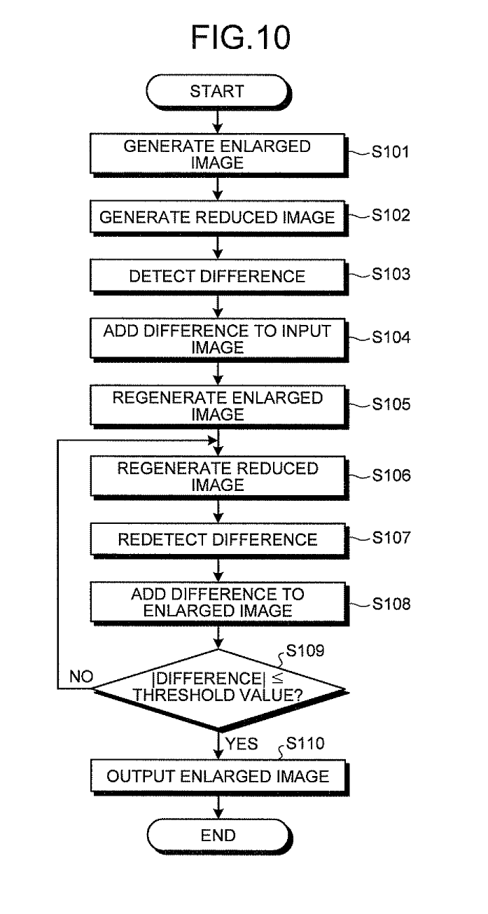

A process performed by the image display device 1 is explained next with reference to FIG. 10. FIG. 10 is a flowchart of a process performed by the image display device 1 according to the present embodiment. FIG. 10 depicts only a process necessary to explain the characteristics of the image display device 1, and descriptions of general processing will be omitted.

Among the processes performed by the image display device 1, a process performed by the image enlarging unit 8 is explained here. As shown in FIG. 10, in the image enlarging unit 8, when an input image is input from the dithering unit 7, the enlarged-image generating unit 81 performs an enlarging process on the input image, thereby generating an enlarged image of the input image (Step S101).

The enlarged-image generating unit 81 generates an enlarged image of 800×480 pixels (VGA) from an input image of 400×234 pixels (EGA) by performing image interpolation by the bilinear method, and outputs the generated enlarged image to the reduced-image generating unit 82.

The reduced-image generating unit 82 generates a reduced image having the same image size (400×234 pixels) as that of the input image from the enlarged image that is input from the enlarged-image generating unit 81 (Step S102), and outputs the generated reduced image to the difference detecting unit 83. At this time, the reduced-image generating unit 82 generates the reduced image by the average thinning method mentioned above, instead of the bilinear method.

Next, the difference detecting unit 83 detects a difference between a pixel value of a pixel on the reduced image input from the reduced-image generating unit 82 and a pixel value of a corresponding pixel on the input image input from the dithering unit 7 (Step S103), and outputs a detected difference between pixel values of each pixel to the former-stage adding unit 841.

At this time, the difference detecting unit 83 detects a difference between a pixel value of a pixel on the input image that is used by the enlarged-image generating unit 81 to generate the enlarged image at Step S101 and a pixel value of a corresponding pixel on the reduced image that is generated by the reduced-image generating unit 82 at Step S102.

Next, the former-stage adding unit 841 adds the difference input from the difference detecting unit 83 to the pixel value of the pixel on the input image input from the dithering unit 7 (Step S104), and outputs the input image having added with the difference to the enlarged-image generating unit 81. At this time, the former-stage adding unit 841 adds a difference between pixel values of a corresponding pixel on the input image that is used by the enlarged-image generating unit 81 to generate the enlarged image at Step S101.

The enlarged-image generating unit 81 then regenerates an enlarged image from the input image to which a difference is added for each pixel that is input from the former-stage adding unit 841 (Step S105), and outputs the regenerated enlarged image to the reduced-image generating unit 82.

The reduced-image generating unit 82 then regenerates a reduced image from the regenerated enlarged image that is input from the enlarged-image generating unit 81 (Step S106), and outputs the regenerated reduced image to the difference detecting unit 83.

Next, the difference detecting unit 83 redetects a difference between a pixel value of a pixel on the regenerated reduced image that is input from the reduced-image generating unit 82 and a pixel value of a corresponding pixel on the input image from the dithering unit 7 (Step S107), and outputs a redetected difference between pixel values of each pixel to the latter-stage adding unit 842.

At this time, the difference detecting unit 83 detects a difference between a pixel value of a pixel on the input image that is used by the enlarged-image generating unit 81 to generate the enlarged image at Step S101 and a pixel value of a corresponding pixel on the reduced image that is regenerated by the reduced-image generating unit 82 at Step S106.

Next, the latter-stage adding unit 842 adds the redetected difference that is input from the difference detecting unit 83 to the enlarged image that is input from the enlarged-image generating unit 81 (Step S108).

At this time, the latter-stage adding unit 842 adds a redetected difference between pixel values of each pixel that is input from the difference detecting unit 83 to a pixel value of a corresponding pixel on the enlarged image, and holds the enlarged image to which the difference is added until a determination result at Step S109 (explained below) is determined.

Next, the difference detecting unit 83 determines whether an absolute value of the difference that is redetected at Step S107 is equal to or smaller than a predetermined threshold value (Step S109). This threshold value can be arbitrarily set.

This threshold value is set as follows, for example. First, the reproducibility of the input image due to the enlarged image is monitored while sequentially changing plural threshold values. As a result of the monitoring, a largest absolute value among threshold values having been determined to have no visual problem in the reproducibility of the input image can be set as the threshold value.

Next, when the difference detecting unit 83 determines that an absolute value of the difference that is redetected at Step S107 is larger than the predetermined threshold value (NO at Step S109), the process shifts to Step S106. In this case, the latter-stage adding unit 842 outputs the held enlarged image to the reduced-image generating unit 82.

On the other hand, when the difference detecting unit 83 determines that an absolute value of the difference that is redetected at Step S107 is equal to or smaller than the predetermined threshold value (YES at Step S109), the latter-stage adding unit 842 outputs the held enlarged image to the timing control unit 9 (Step S110), and ends the process.

As described above, the image display device according to the present embodiment corrects a pixel value of a pixel on the input image while assuming a decrease of the reproducibility of the input image by the enlarging process. The image display device then regenerates an enlarged image from the input image of which a pixel value of a pixel is corrected.

Therefore, the image display device according to the present embodiment can regenerate an enlarged image with a reproducibility of the input image higher than that of the enlarged image generated from an initially input image of which a pixel value of a pixel is not corrected.

Further, the image display device according to the present embodiment regenerates the enlarged image by adding a difference between a pixel value of a pixel on the reduced image of the regenerated enlarged image and a pixel value of a pixel on the initially input image to a pixel value of a corresponding pixel on the regenerated enlarged image. Therefore, the image display device can generate an enlarged image with a reproducibility of the input image higher than that of an enlarged image regenerated from the input image of which a pixel value of a pixel is corrected.

The image display device according to the present embodiment can repeat an addition of a difference to an enlarged image, a regeneration of a reduced image from an enlarged image to which a difference is added, and a detection of a difference between a pixel value of a pixel on the regenerated reduced image and a pixel value of a pixel on the input image, until a predetermined ending condition is satisfied.

With the above arrangement, the image display device according to the present embodiment can improve the reproducibility of the input image due to the enlarged image without performing the enlarging process of the input image, only by repeatedly adding a difference between a pixel value of a pixel on a reduced image and a pixel value of a pixel on the input image to a pixel value of a corresponding pixel on the enlarged image after generating the enlarged image once.

As described above, the image display device according to the present embodiment can generate an enlarged image of an improved reproducibility of the input image. Therefore, the image display device can display a high-precision enlarged image while utilizing the resolution of a display unit when an input image with a resolution lower than that of the display unit is enlarged and displayed.

Therefore, the image display device according to the present embodiment can display an enlarged image by correctly reproducing edges of a subject of an image in one-segment broadcasting and characters and diagonal lines of an image of a car navigation system, for example, while utilizing the resolution of the display unit.

In the embodiment described above, although there have been explained an addition of a difference to a pixel value of a pixel on the input image and an addition of a difference to a pixel value of a pixel on the enlarged image, it also suffices to perform only one of these additions.

For example, when a difference between a pixel value of a pixel on a reduced image of a regenerated enlarged image and a pixel value of a corresponding pixel on the input image is equal to or smaller than a predetermined threshold value as a result of an addition of a difference to a pixel value of a pixel on an input image, an addition of a difference to a pixel value of a pixel on the enlarged image can be omitted.

As explained above, when the reproducibility of the input image due to the enlarged image is improved only by adding a difference to a pixel value of the input image, a processing amount of the image display device can be reduced by omitting the addition of a difference to a pixel value of the input image.

Further, it can be arranged such that an addition of a difference to a pixel value of the input image is not performed and that a difference between a pixel value of a pixel on a reduced image of an enlarged image that is generated from the input image and a pixel value of a pixel on the input image is added to a pixel value of the pixel on the enlarged image, and when a difference between a pixel value of a pixel on a reduced image of the enlarged image to which the pixel value is added and a pixel value of the pixel on the input image is equal to or smaller than a predetermined threshold value, the enlarged image to which the pixel value is added can be displayed. Also with this arrangement, the processing amount of the image display device can be reduced.

In the embodiment described above, although a difference is added to a pixel value of a pixel on the input image for once, the addition can be performed for plural times. That is, it is possible to repeat an addition of a difference to a pixel value of a pixel on the input image, a regeneration of an enlarged image from the input image to which a difference is added, a regeneration of a reduced image from the regenerated enlarged image, and a detection of a difference between a pixel value of a pixel on the regenerated reduced image and a pixel value of a pixel on the input image.

In the embodiment described above, an addition of a difference to a pixel value of a pixel on the input image and an addition of a difference to a pixel value of a pixel on the enlarged image are performed in this order. Alternatively, these additions can be performed in the order of an addition of a difference to a pixel value of a pixel on the enlarged image and an addition of a difference to a pixel value of a pixel on the input image.

When the number of repeating processes is increased or when an order of processes is changed in this way, the reproducibility of the input image due to the enlarged image can be also improved in a similar manner to that of the embodiment described above.

Respective constituent elements of respective units shown in the drawings do not necessarily have to be physically configured in the way as shown in these drawings. That is, the specific mode of distribution and integration of respective units is not limited to the shown ones and all or a part of these units can be functionally or physically distributed or integrated in an arbitrary unit, according to various kinds of load, the status of use or the like.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image display device comprising:
an enlarged-image generating unit that generates an enlarged image by performing an enlarging process on an input image;
a reduced-image generating unit that generates a reduced image by performing a reducing process other than an inverse process of the enlarging process on the enlarged image;
a difference detecting unit that detects a difference between a pixel value of a pixel on the reduced image and a pixel value of a corresponding pixel on the input image; and
a correcting unit that corrects a pixel value of a pixel on the input image or the enlarged image based on the difference that is detected by the difference detecting unit.

2. The image display device according to claim 1, wherein
the difference detecting unit redetects a difference between a pixel value of a pixel on a reduced image and a pixel value of a corresponding pixel on the input image after the correcting unit corrects a pixel value of a pixel on the input image, the reduced image being regenerated by the reduced-image generating unit from an enlarged image that is regenerated by the enlarged-image generating unit, and
the correcting unit corrects a pixel value of a pixel on the enlarged image based on the difference.

3. The image display device according to claim 2, wherein the image display device repeats a correction of a pixel value of a pixel on the enlarged image by the correcting unit, a regeneration of the reduced image by the reduced-image generating unit, and a redetection of a difference by the difference detecting unit, until the difference detected by the difference detecting unit meets a predetermined terminal condition.

4. An image display method comprising:
generating an enlarged image by performing an enlarging process on an input image;
generating an reduced image by performing a reducing process other than an inverse process of the enlarging process on the enlarged image;
detecting a difference between a pixel value of a pixel on the reduced image and a pixel value of a corresponding pixel on the input image; and
correcting a pixel value of a pixel on the input image or the enlarged image based on the difference that is detected.
